(19) United States
(12) Patent Application Publication
(10) Pub. No.: US 2023/0013825 A1
(43) Pub. Date: Jan. 19, 2023

(54) System and Related Methods for Digital Cash Transfers and Remittance

(71) Applicant: MAROUANE CHERKAOUI, CASABLANCA (MA)

(72) Inventor: MAROUANE CHERKAOUI, CASABLANCA (MA)

(21) Appl. No.: 17/832,434

(22) Filed: Jun. 3, 2022

Related U.S. Application Data
(60) Provisional application No. 63/218,881, filed on Jul. 6, 2021.

(51) Int. Cl. G06Q 20/06; G06Q 40/02; G06Q 40/06; G06Q 20/36; G06Q 20/38

(52) U.S. Cl. CPC G06Q 20/06; G06Q 40/02; G06Q 40/06; G06Q 20/36; G06Q 20/382

(57) ABSTRACT

The present disclosure provides a method for users to convert physical currency into digital currency and to store and transfer that digital currency from an electronic wallet by interfacing with one or more liquidity providers in a network of liquidity providers. The method and related systems can be accessed and implemented via dedicated application software on a user device, and do not require a bank account. A minimum reserve amount held by each liquidity provider ensures that conversions between digital and physical currency is always seamless, and transaction fees may be calculated at a fixed percentage of transacted funds.

### CROSS REFERENCES TO RELATED APPLICATIONS

The present application claims the benefit and priority of US provisional application no. U.S. 63/218,881, filed Jul. 6, 2021.

### FIELD OF INVENTION

The present invention relates generally to methods and systems for converting physical currency into digital currency and storing and transferring that digital currency between electronic wallets.

### BACKGROUND

Many solutions now exist for the conversion of physical funds or “cash” into electronic funds and the transfer of such funds between user accounts and users in remote locations. The three main branches of these solutions are the more traditional electronic banking related solutions, postal type money transfers by institutions such as Western Union and Moneygram, and the more modern attempts to circumvent the traditional financial institutions through decentralized peer-to-peer transactions and cryptocurrency. However, all of these solution branches still have their own respective problems.

For the banking solutions, the main and circumventable problem is that a vast number of users, especially in third world countries, do not have bank accounts. Indeed, bank accounts are not attainable for many of these individuals due to circumstances beyond their control. Outside of cryptocurrency and Western Union type solutions there are no dedicated and reliable methods for storing or transferring cash without a bank account.

For institutional solutions such as Western Union and Moneygram there are two obstacles to overcome: the requirement that users are technologically proficient enough to understand their systems, and the high transaction fees. The transaction fees are high because these institutions are franchises that have their own operating costs, which are passed on to the service provider enacting their transactions, and then in turn are passed on to the end users.

Finally, we come to cryptocurrencies. While they also put a high technological burden on the end user, cryptocurrencies' main problem is that the transaction fees for sending funds between electronic wallets of a network can vary vastly depending on network activity, fluctuating to ridiculous extent and making the network practically unusable during high activity periods.

It is within this context that the present invention is provided.

### SUMMARY

The present disclosure provides a method for users to convert physical currency into digital currency and to store and transfer that digital currency from an electronic wallet by interfacing with one or more liquidity providers in a network of liquidity providers. The method and related systems can be accessed and implemented via dedicated application software on a user device, and do not require a bank account. A minimum reserve amount held by each liquidity provider ensures that conversions between digital and physical currency is always seamless, and transaction fees may be calculated at a fixed percentage of transacted funds.

In some examples the liquidity providers are merchants such as grocery stores and currency exchange points, thereby leveraging an existing network of actors to transfer currency between remote locations, with no requirement for the involvement of a bank, and minimal requirement for technological proficiency. The lack of requirement for a liquidity provider to be a franchise of a money transfer company also lowers the costs incurred by liquidity providers and facilitates low transfer fees. A custodian holds an amount of funds corresponding to the amount of digital currency issued via the method to ensure the safety of users' funds.

This “digital cash” system enables easy remittance between unbanked users, as well as convenient storing of their funds. Liquidity providers in turn generate increased foot traffic at their locations and may be eligible to receive portions of transfer fees for digital currency transactions enacted at their store locations.

Thus, according to one aspect of the present disclosure there is provided a computer-implemented method for managing funds, the method comprising the steps of: receiving, by a custodian, fund deposits from one or more liquidity providers; issuing for each fund deposit, by the custodian to a set of user accounts associated with the one or more liquidity providers, a corresponding amount of a digital asset; receiving, by the one or more liquidity providers, cash deposits from one or more users; verifying, by the one or more liquidity providers, the identity of the user submitting each cash deposit; issuing for each cash deposit from a verified user, by the one or more liquidity providers, a corresponding amount of the digital currency to an associated user account of that user.

The amount of fund deposits and the amount of the digital asset held by each of the custodian, the one or more liquidity providers, and the one or more users, as well as each transaction carried out between custodian, the one or more liquidity providers, and the one or more users, is recorded in an electronic wallet database, each wallet in the wallet database being associated with user data relating to the identity of the wallet owner.

At any time, funds held by the custodian should be equal to the total digital currency (dCash) balance of all participants (users and liquidity providers) but other iterations of the present system and method can give the ability to the custodian to issue more digital currency than funds held on behalf of liquidity providers to allow lending and borrowing mechanisms for instance.

In some embodiments, the method further comprises: setting, for each liquidity provider, a minimum reserve amount; checking the database to determine whether a first liquidity provider holds an amount of the digital asset corresponding to the minimum reserve amount; determining that the amount of the digital asset held by the first liquidity provider is below the minimum reserve amount; and initiating a protocol to prevent further transactions between the first liquidity provider and the one or more users until the amount of the digital asset held by the first liquidity provider is above the minimum reserve amount.

The protocol may involve one of freezing the assets of the first liquidity provider and freezing a user account associated with the first liquidity provider.

The method may also further comprise, in response to receiving an additional fund deposit from the liquidity provider which brings the amount of digital currency held by the first liquidity provider above the minimum reserve amount: unfreezing the assets or user account of the first liquidity provider.

In some embodiments, the method further comprises: receiving a remittance request from a first user to transfer funds from a cash deposit to a second user, the request specifying an amount to be deposited and transferred; generating a unique identifier for the transfer request; communicating the unique identifier to the second user; receiving, by a first liquidity provider, a cash deposit from the first user; verifying, by the first liquidity provider, the identity of the first user; verifying, by the first liquidity provider, that the amount of the cash deposit corresponds to the amount specified in the remittance request; and transferring, by the first liquidity provider, an amount of digital currency corresponding to the cash deposit to an account associated with the second user.

The method may also further comprise: receiving, by a second liquidity provider, a withdrawal request from the second user; verifying, by the second liquidity provider, that the identity of the second user corresponds to the second user account; and issuing to the second user, by the second liquidity provider, a cash amount corresponding to the amount of digital currency transferred to their account.

The method may also further comprises calculating and deducting a percentage fee from the transferred amount of digital currency. In such cases, the method may also further comprise distributing at least a portion of the fee to an account wallet associated with the custodian and/or distributing at least a portion of the fee to an account wallet associated with the first liquidity provider, and/or distributing at least a portion of the fee to an account wallet associated with the second liquidity provider.

In some embodiments, the method further comprises storing contact information and transaction history for the one or more user account wallets, liquidity provider account wallets in the database.

In some embodiments, the method further comprises: receiving, by a first liquidity provider, a withdrawal request specifying a desired withdrawal amount from the first user; verifying, by the first liquidity provider, that the identity of the first user corresponds to a first user account having a wallet containing a sufficient amount of the digital currency for the withdrawal; and issuing to the first user, by the first liquidity provider, a cash amount corresponding to the amount in the withdrawal request. It may also comprise deducting a percentage fee from the withdrawal amount and distributing the fee to an account wallet of the first liquidity provider.

In some embodiments, the method further comprises: receiving, by a first liquidity provider, a deposit request specifying a desired deposit amount from the first user; verifying, by the first liquidity provider, that the identity of the first user corresponds to a first user account; receiving, from the first user, a cash deposit equal to the deposit amount; and issuing to a wallet of the first user account, by the first liquidity provider, an amount of digital currency corresponding to the deposit amount.

It may also further comprise deducting a percentage fee from the deposit amount and distributing the fee to an account wallet of the first liquidity provider.

In some embodiments, the method further comprises calculating currency conversion rates for one or more operations between account wallets stored in the database.

In some embodiments, one or more users, the one or more liquidity providers, and the custodian may view wallet balances and initiate operations of the disclosed method via dedicated application software installed on one or more user devices.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

### Definitions

The term “cash” as used herein generally refers to fiduciary money such as banknotes and coins in circulation in traditional economies.

The term “digital cash” or “dCash” as referred to herein generally refers to cash after being digitized through the present system and method.

The term “front-end application” as referred to herein generally refers to a software component of a web and mobile application viewable by a user and which the user of a client device can interact with to take advantage of the operations and benefits described herein.

The term “back-end application” as referred to herein generally refers to a software component of the same web and mobile application which is not accessible or interactable by a user of a client device. This may comprise a database and one or more servers as described herein.

The term “system” as used herein generally refers to a software application, system, or platform that comprises both the back-end application and front-end application software components.

The term “remittance” as used herein generally refers to the process of transferring cash from one user to another using the methods and system described herein. The term remittance is used in place of the term transfer, since the process involves a first conversion from the sender's cash to dCash, a transfer of dCash, and then a second conversion of the dCash to cash at the recipient's location.

The term “user” as used herein generally refers to a customer making use of the disclosed system and methods to deposit, withdraw, send, or receive cash or dCash according to the disclosed methods.

As discussed herein, the term “user account” generally refers to an account maintained on behalf of a user to facilitate at least one of tracking of user data and currency amounts from their electronic wallet.

The term “liquidity provider” as used herein generally refers to an affiliated merchant (for example, a grocery store owner, currency exchange store, etc.) who acts as a node in the network of the system and assist with implementing the disclosed operations.

As discussed herein, the term “liquidity provider account” generally refers to an account maintained on behalf of a merchant to facilitate at least one of tracking of user data and currency amounts from their electronic wallet.

The term “custodian” as used herein generally refers to a third party that acts as the custodian of funds deposited in the system, holding cash in one or more vaults or bank accounts and issuing equivalent or greater amounts of dCash in exchange for deposited funds.

The term “participants” as used herein generally encompasses all user components of the system, including users, liquidity providers, and custodians as defined above.

In some examples, fees are deducted from funds transferred, withdrawn, remitted, or transferred using the disclosed system. Below is an example schedule summarizing which participant(s) the deducted funds are distributed to for each respective operation type carried out over the system.

| Type of operation | Liquidity providers | Custodian |
|---|---|---|
| Cash-in | X | |
| Cash-out | X | |
| Cash remittance | X | X |
| dCash transfer | | X |

In terms of possible hardware and network configurations, the user devices and servers making up the system may communicate with via any number of device types such as a keyboard, a pointing device, a display, etc; one or more devices that enable a user to interact with computer system; and/or any devices (e.g., network card, modem, etc.) that enable computer system to communicate with one or more other computing devices. Such communication can occur via Input/Output (I/O) interfaces. Still yet, computer system can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, aspects of the present disclosure may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including a domain specific programming language such as SQL. SQL, or Structured Query Language, is designed for managing data held in a relational database management system, or for stream processing in a relational data stream management system. The databases may also use document-based languages for storing unstructured menu information.

Other programming languages may also be used to the same effect, including object oriented programming languages such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog.

The program code may execute entirely on a server, partly on a server, as a stand-alone software package, or partly on a user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be understood that the operations described herein may be carried out by any suitable processor configuration.

In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

### Specific Examples of Use

In the following set of examples, interactions between one or more users, one or more liquidity providers, and the custodian over the disclosed system are exemplified with example conversion and fee calculations, for each type of operation.

For operations between two different users, the term “used” is used to refer to the sending party, the terms “LP1” is used to refer to the liquidity provider used by the sending party, the term “user2” is used to refer to the receiving party, and the term “LP2” is used to refer to the liquidity provider used by the receiving party.

For each transaction, a table is given which shows the initial balances of all parties involved in the transaction, as well as at least one table showing the resulting balances after the transaction.

### Section I: Classic Remittance Type Operations:

Process: LP1 authenticates Used by checking his ID. Used gives cash to LP1. LP1 initiates the cash remittance operation on behalf of Used. Used checks the transaction details and authorizes it. User2 receives a code that he gives to LP2. LP2 authenticates User2 by checking his ID. LP2 gives cash to User2.

Amount of cash to remit: 100$

LP1 fees: 2.5% LP2 fees: 2.5% Custodian fees: 1%

LP1 holdings: 4,000$ in cash and 3,000$ held by custodian (3,000$ dCash balance). Total of 7,000$.

LP2 holding: 3,000$ in cash and 2,000$ held by custodian (2,000$ dCash balance). Total of 5,000$.

Custodian: 5,000$ held on behalf of LP1 and LP2.

The cash remittance fees could either be paid by User1, by User2 or split between the two as illustrated in the following examples.

### Example 1: User1 Chooses to Pay the Fees

Fees: User1 sends 106$. User2 receives 100$. User1 will have to pay 6$ in fees (2.5$ LP1 fees+1$ custodian fees+2.5$ LP2 fees).

Initial balances:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 106$ | 0$ | n/a | 106$ | 0$ | 0$ |
| User2 | 0$ | 0$ | n/a | 0$ | 0$ | 0$ |
| LP1 | 4,000$ | 3,000$ | n/a | 7.000$ | 0$ | 0$ |
| LP2 | 3,000$ | 2,000$ | n/a | 5.000$ | 0$ | 0$ |
| Total | 7,106$ | 5,000$ | n/a | 12.106$ | 0$ | 0$ |
| Custodian | 0$ | 0$ | 5.000$ | 5.000$ | 0$ | 0$ |

Cashing-in by User1:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 103.5$ | n/a | 103.5$ | 2.5$ | 0$ |
| | (106$) | (+106$ | | | | |
| | | −2.5$ LP1 | | | | |
| | | fees) | | | | |
| User2 | 0$ | 0$ | n/a | 0$ | 0$ | 0$ |
| LP1 | 4,106$ | 2,886.5$ | n/a | 7,002.5$ | 0$ | 2.5$ |
| | (+106$) | (−106$ → | | | | |
| | | 2.5$ LP1 | | | | |
| | | fees) | | | | |
| LP2 | 3,000$ | 2,000$ | n/a | 5,000$ | 0$ | 0$ |
| Total | 7,106$ | 5,000$ | n/a | 12,106$ | 2.5$ | 2.5$ |
| Custodian | 0$ | 0$ | 5,000$ | 5,000$ | 0$ | 0$ |

dCash transfer:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 2.5$ | n/a | 2.5$ | 1$ | 0$ |
| | | (−100$ −1$ | | | | |
| | | custodian | | | | |
| | | fees) | | | | |
| User2 | 0$ | 100$ | n/a | 100$ | 0$ | 0$ |
| | | (+100$) | | | | |
| LP1 | 4,106$ | 2,896.5$ | n/a | 7,002.6$ | 0$ | 0$ |
| LP2 | 3,000$ | 2,000$ | n/a | 5,000$ | 0$ | 0$ |
| Total | 7,106$ | 4,999$ | n/a | 12,105$ | 1$ | 0$ |
| Custodian | 0$ | 1$ | 4,999$ | 5,000$ | 0$ | 1$ |
| | | (+1$ | | | | |
| | | castodan | | | | |
| | | fees) | | | | |

Cashing-out by User2:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 0$ | n/a | 0$ | 2.5$ | 0$ |
| | | (−2.5$ | | | | |
| | | LP2 fees) | | | | |
| User2 | 100$ | 0$ | n/a | 100$ | 0$ | 0$ |
| | | (−100$) | | | | |
| LP1 | 4,106$ | 2,896.6$ | na | 7,002.5$ | 0$ | 0$ |
| LP2 | 2,900$ | 2,102.5$ | n/a | 5,002.5$ | 0$ | 2.5$ |
| | (−100$) | (+100$ +2.5 | | | | |
| | | LP2 fees) | | | | |
| Total | 7,106$ | 4,999$ | n/a | 12,105$ | 2.5$ | 2.5$ |
| Custodian | 0$ | 1$ | 4,909$ | 5,000$ | 0$ | 0$ |

### Example 2: User1 Chooses to Split the Fees

Fees: User1 sends 103$. User2 receives 97$. User1 will have to pay 3$ in fees (2.5$ LP1 fees+0.5$ custodian fees) User2 will have to pay 3$ in fees (2.5$ LP1 fees+0.5$ custodian fees)

Initial balances:

| | | | Funds held | | | |
|---|---|---|---|---|---|---|
| | | | by the | | | |
| | | | custodian | | | |
| | | | on behalf of | | | |
| Holdings | Cash balance | dCash balance | LP | Total | Fees paid | Fees earned |
| User1 | 103$ | 0$ | n/a | 103$ | 0$ | 0$ |
| User2 | 0$ | 0$ | n/a | 0$ | 0$ | 0$ |
| LP1 | 4,000$ | 3,000$ | n/a | 7,000$ | 0$ | 0$ |
| LP2 | 3,000$ | 2,000$ | n/a | 5,000$ | 0$ | 0$ |
| Total | 7,103$ | 5,000$ | n/a | 12,103$ | 0$ | 0$ |
| Custodian | 0$ | 0$ | 5,000$ | 5,000$ | 0$ | 0$ |

Cashing-in by User1:

| | | | Funds held | | | |
|---|---|---|---|---|---|---|
| | | | by the | | | |
| | | | custodian | | | |
| | | | on behalf of | | | |
| Holdings | Cash balance | dCash balance | LP | Total | Fees paid | Fees earned |
| User1 | 0$ | 100.5$ | n/a | 100.5$ | 2.5$ | 0$ |
| | (−103$) | (+103$ | | | | |
| | | −2.5$ | | | | |
| | | LP1 fees) | | | | |
| User2 | 0$ | 0$ | n/a | 0$ | 0$ | 0$ |
| LP1 | 4,103$ | 2,899.5$ | n/a | 7,002.5$ | 0$ | 2.5$ |
| | (+103$) | (−103$ | | | | |
| | | +2.5$ | | | | |
| | | LP1 fees) | | | | |
| LP2 | 3,000$ | 2,000$ | n/a | 5,000$ | 0$ | 0$ |
| Total | 7,103$ | 5,000$ | n/a | 12,103$ | 2.5$ | 2.5$ |
| Custodian | 0$ | 0$ | 5,000$ | 5,000$ | 0$ | 0$ |

dCash transfer:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 0$ | n/a | 0$ | 0 5$ | 0$ |
| | | (−100$ | | | | |
| | | −0.5$ | | | | |
| | | custodian | | | | |
| | | fees) | | | | |
| User2 | 0$ | 99.5$ | n/a | 99.5$ | 0.5$ | 0$ |
| | | (+100$ | | | | |
| | | −0.5$ | | | | |
| | | custodian | | | | |
| | | fees) | | | | |
| LP1 | 4,103$ | 2,899.5$ | n/a | 7,002.5$ | 0$ | 0$ |
| LP2 | 3,000$ | 2,000$ | n/a | 5,000$ | 0$ | 0$ |
| Total | 7,103$ | 4,999$ | n/a | 12,102$ | 1$ | 0$ |
| Custodian | 0$ | 1$ | 4,999$ | 5,000$ | 0$ | 1$ |
| | | (+1$ | | | | |
| | | custodian | | | | |
| | | fees) | | | | |

Cashing-out by User2:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 0$ | n/a | 0$ | 0$ | 0$ |
| User2 | 97$ | 0$ | n/a | 97$ | 2.5$ | 0$ |
| | (+97$) | (−97$ −2.5$ | | | | |
| | | LP1 fees) | | | | |
| LP1 | 4,103$ | 2,899.5$ | n/a | 7,002.5$ | 0$ | 0$ |
| LP2 | 2,903$ | 2,099.5$ | n/a | 5,002.5$ | 0$ | 2.5$ |
| | (97$) | (+97$ +2.5 | | | | |
| | | LP2 fees) | | | | |
| Total | 7,103$ | 4,999$ | n/a | 12,102$ | 2.5$ | 2.5$ |
| Custodian | 0$ | 1$ | 4,999$ | 5,000$ | 0$ | 0$ |

### Example 3: User1 Lets User2 Pay the Fees

User2 will have to pay 6$ in fees (2.5$ LP1 fees+1$ custodian fees+2.5$ LP2 fees).

Initial balances:

| | | | Funds held | | | |
|---|---|---|---|---|---|---|
| | | | by the | | | |
| | | | custodian | | | |
| | | | on behalf of | | | |
| Holdings | Cash balance | dCash balance | LP | Total | Fees paid | Fees earned |
| User1 | 100$ | 0$ | n/a | 100$ | 0$ | 0$ |
| User2 | 0$ | 0$ | n/a | 0$ | 0$ | 0$ |
| LP1 | 4,000$ | 3,000$ | n/a | 7,000$ | 0$ | 0$ |
| LPZ | 3,000$ | 2,000$ | n/a | 5,000$ | 0$ | 0$ |
| Total | 7,100$ | 5,000$ | n/a | 12,100$ | 0$ | 0$ |
| Custodian | 0$ | 0$ | 5,000$ | 5,000$ | 0$ | 0$ |

Cashing-in by User1:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 100$ | n/a | 100$ | 0$ | 0$ |
| | (−100$) | (+100$) | | | | |
| User2 | 0$ | 0$ | n/a | 0$ | 0$ | 0$ |
| LP1 | 4,100$ | 2,900$ | n/a | 7,000$ | 0$ | 0$ |
| | (+100$) | (−100$) | | | | |
| LP2 | 3,000$ | 2,000$ | n/a | 5,000$ | 0$ | 0$ |
| Total | 7,100$ | 5,000$ | n/a | 12,100$ | 0$ | 0$ |
| Custodian | 0$ | 0$ | 5,000$ | 5,000$ | 0$ | 0$ |

dCash transfer:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 0$ (−100$) | n/a | 0$ | 0$ | 0$ |
| User2 | 0$ | 99$ | n/a | 99$ | 1$ | 0$ |
| | | (+100$ −1$ | | | | |
| | | custodian | | | | |
| | | fees) | | | | |
| LP1 | 4,100$ | 2,900$ | n/a | 7,000$ | 0$ | 0$ |
| LP2 | 3,000$ | 2,000$ | n/a | 5,000$ | 0$ | 0$ |
| Total | 7,100$ | 4,999$ | n/a | 12,099$ | 1$ | 0$ |
| Custodian | 0$ | 1$ | 4,999$ | 5,000$ | 0$ | 1$ |
| | | (+1$ | | | | |
| | | custodian | | | | |
| | | fees) | | | | |

Cashing-out by User2:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User1 | 0$ | 0$ | n/a | 0$ | 0$ | 0$ |
| User2 | 94$ | 0$ | n/a | 94$ | 5$ | 0$ |
| | (+94$) | (−94$ +2.5$ | | | | |
| | | LP1 fees | | | | |
| | | −2.5$ LP2 | | | | |
| | | fees) | | | | |
| LP1 | 4,100$ | 2,902.5$ | n/a | 7,002.5$ | 0$ | 2.5$ |
| | | (+2.5$ LP1 | | | | |
| | | fees) | | | | |
| LP2 | 2,906$ | 2,090.5$ | n/a | 5,002.5$ | 0$ | 2.5$ |
| | (−94$) | (+94$ +2.5 | | | | |
| | | LP2 fees) | | | | |
| Total | 7,100$ | 4,999$ | n/a | 12,099$ | 5$ | 5$ |
| Custodian | 0$ | 1$ | 4,999$ | 5,000$ | 0$ | 0$ |

### Section II: Cashing-In Operations

Amount of cash to convert to dCash: 100$

LP fees: 2.5% of cash to convert or 2.5$ Custodian fees: n/a

LP holdings: 4,000$ in cash and 3,000$ held by custodian (3,000$ in dCash balance). Total of 7,000$.

Custodian: 3,000$ held on behalf of LP.

Process: LP authenticates User by checking his ID. User gives cash to LP. User checks the transaction details and authorizes it. LP executes the cash-in operation. User wallet is credited with a dCash amount equal to the cash deposited minus fees paid.

### Example

User deposits 102.5$ in cash in exchange for 100$ in dCash. User will have to pay 2.5$ in fees.

Initial balances:

| | | | Funds held | | | |
|---|---|---|---|---|---|---|
| | | | by the | | | |
| | | | custodian | | | |
| | | | on behalf of | | | |
| Holdings | Cash balance | dCash balance | LP | Total | Fees paid | Fees earned |
| User | 102.5$ | 0$ | n/a | 102.5$ | 0$ | 0$ |
| LP | 4,000$ | 3,000$ | n/a | 7,000$ | 0$ | 0$ |
| Total | 4,102.5$ | 3,000$ | n/a | 7,102.5$ | 0$ | 0$ |
| Custodian | 0$ | 0$ | 3,000$ | 3,000$ | 0$ | 0$ |

Cashing-in by User:

| | | | Funds held | | | |
|---|---|---|---|---|---|---|
| | | | by the | | | |
| | | | custodian | | | |
| | Cash | dCash | on behalf of | | | Fees |
| Holdings | balance | balance | LP | Total | Fees paid | earned |
| User | 0$ | 100$ | n/a | 1100$ | 2.5$ | 0$ |
| | ($100$ 2.5$ | (+100$) | | | | |
| | LP fees) | | | | | |
| LP | 4,102.5$ | 2,900$ | n/a | 7,002.5$ | 0$ | 2.5$ |
| | (+100$ | (−100$) | | | | |
| | +2.5$ LP | | | | | |
| | fees) | | | | | |
| Total | 4,102.5$ | 3,000$ | n/a | 7,102.5$ | 2.5$ | 2.5$ |
| Custodian | 0$ | 0$ | 3,000$ | 3,000$ | 0$ | 0$ |

### Section II: Cashing-Out Operations

Process: LP authenticates User by checking his ID. User sends dCash to LP wallet. LP executes the cash-out operation. User wallet is debited with a dCash amount equal to the cash withdrawn minus fees paid.

Amount of dCash to convert to cash: 100$

LP fees: 2.5% of cash to convert or 2.5$ Custodian fees: n/a

LP holdings: 3,000$ in cash and 2,000$ held by custodian (2,000$ in dCash balance). Total of 5,000$.

Custodian: 2,100$ held on behalf of User and LP.

### Example

User withdraws 97.5$ in cash in exchange for 100$ in dCash. User will have to pay 2.5$ in fees.

Initial balances:

| | | | Funds held | | | |
|---|---|---|---|---|---|---|
| | | | by the | | | |
| | | | custodian | | | |
| | | | on behalf of | | | |
| Holdings | Cash balance | dCash balance | LP | Total | Fees paid | Fees earned |
| User | 0$ | 100$ | n/a | 100$ | 0$ | 0$ |
| LP | 3,000$ | 2,000$ | n/a | 5,000$ | 0$ | 0$ |
| Total | 3,000$ | 2,100$ | n/a | 5,100$ | 0$ | 0$ |
| Custodian | 0$ | 0$ | 2,100$ | 2,100$ | 0$ | 0$ |

Cashing-out by User:

| | | | Funds held | | | |
|---|---|---|---|---|---|---|
| | | | by the | | | |
| | | | custodian | | | |
| | Cash | dCash | on behalf of | | | Fess |
| Holdings | balance | balance | LP | Total | Fees paid | earned |
| User | 97,5$ | 0$ | n/a | 97.5$ | 2.5$ | 0$ |
| | (+97.5$) | (−97.5$ | | | | |
| | | −2.5$ LP | | | | |
| | | fees) | | | | |
| LP | 2,902 5$ | 2,100$ | n/a | 5,002.5$ | 0$ | 2.5$ |
| | (−97.5$) | (+97.5$ +2.5 | | | | |
| | | LP fees) | | | | |
| Total | 3,000$ | 2,100$ | n/a | 5,100$ | 2.5$ | 2.5$ |
| Custodian | 0$ | 0$ | 2,100$ | 2,100$ | 0$ | 0$ |

Section IV: dCash Transfer Operations

Process: User1 connects to his wallet, finds User2 wallet and sends him dCash by signing and authorizing the transaction.

Amount of dCash to send: 100$

Custodian fees: 1% of cash to send or 1$.

### Example 1: User1 Chooses to Pay the Fees

Fees: User1 sends 100$ to User2. User2 receives 99$. User1 pays 1$ in fees.

Initial balances:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0$ | 100$ | n/a | 100$ | 0$ | 0$ |
| User2 | 0$ | 0$ | n/a | 0$ | 0$ | 0$ |
| Total | 0$ | 100$ | n/a | 100$ | 0$ | 0$ |
| Custodian | 0$ | 0$ | 100$ | 100$ | 0$ | 0$ |

Cashing-out by User:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0$ | 0$ | n/a | 0$ | 1$ | 0$ |
| | | (−99$ −1$ | | | | |
| | | custodian | | | | |
| | | fees) | | | | |
| User2 | 0$ | 90$ | n/a | 99$ | 0$ | 0$ |
| | | (+99$) | | | | |
| Total | | 99$ | n/a | 99$ | 1$ | 0$ |
| Custodian | 0$ | 1$ | 99$ | 100$ | 0$ | 1$ |
| | | (+1$ | | | | |
| | | custodian | | | | |
| | | fees) | | | | |

### Example 2: User1 Chooses to Split the Fees

Fees: User1 sends 100.5$ to User2. User2 receives 99.5$. User1 pays 0.5$ in fees. User2 pays 0.5$ in fees.

Initial balances:

| | | | Funds held | | | |
|---|---|---|---|---|---|---|
| | | | by the | | | |
| | | | custodian | | | |
| | | | on behalf of | | | |
| Holdings | Cash balance | dCash balance | LP | Total | Fees paid | Fees earned |
| User1 | 0$ | 100.5$ | n/a | 100.5$ | 0$ | 0$ |
| User2 | 0$ | 0$ | n/a | 0$ | 0$ | 0$ |
| Total | 0$ | 100.5$ | n/a | 100.5$ | 0$ | 0$ |
| Custodian | 0$ | 0$ | 100.5$ | 100.5$ | 0$ | 0$ |

Cashing-out by User:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0$ | 0$ | n/a | 0$ | 0.5$ | 0$ |
| | | (−100$ −0.5$ | | | | |
| | | custodian | | | | |
| | | fees) | | | | |
| User2 | 0$ | 99.5$ | n/a | 99.5$ | 0.5$ | 0$ |
| | | (+100$ | | | | |
| | | −0.5$ | | | | |
| | | custodian | | | | |
| | | fees) | | | | |
| Total | 0$ | 99.5$ | n/a | 99.5$ | 1$ | 0$ |
| Custodian | 0$ | 1$ | 99.5$ | 100.5$ | 0$ | 1$ |
| | | (+1$ | | | | |
| | | custodian | | | | |
| | | fees) | | | | |

### Example 3: User1 Lets User2 Pay the Fees

Fees: User1 sends 101$ to User2. User2 receives 100$. User2 pays 1$ in fees.

### Initial Balances:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0$ | 101$ | n/a | 101$ | 0$ | 0$ |
| User2 | 0$ | 0$ | n/a | 0$ | 0$ | 0$ |
| Total | 0$ | 101$ | n/a | 101$ | 0$ | 0$ |
| Custodian | 0$ | 0$ | 101$ | 101$ | 0$ | 0$ |

Cashing-out by User:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0$ | 0$ | n/a | 0$ | 0$ | 0$ |
| | | (−101$) | | | | |
| User2 | 0$ | 100$ | n/a | 100$ | 1$ | 0$ |
| | | (+101$ −1$ | | | | |
| | | custodian | | | | |
| | | fees) | | | | |
| Total | 0$ | 100$ | n/a | 100$ | 1$ | 0$ |
| Custodian | 0$ | 1$ | 100$ | 101$ | 0$ | 1$ |
| | | (+1$ | | | | |
| | | custodian | | | | |
| | | fees) | | | | |

### Section V: Liquidity Provider Reserve

When joining the present system and method LP must deposit an amount higher than the level of “reserve” agreed upon with the Custodian.

For example, assume that a LP has a store where he can provide 10,000$ to users and deposits another 10,000$ to the Custodian's bank account, for which 10,000$ worth of dCash is issued.

If LP agrees that the amount of the “reserve” is 3,000$ then the balance of dCash shown on LP wallet should always be higher than 3,000$ to continue using the app.

It is crucial for the present system and method to keep working smoothly that LP maintain their reserves. Thus, they need to supply the excess cash they collected to the custodian. The application will have to include mechanisms preventing LP from consuming their reserves. Such mechanisms could include: sending alerts or freezing the app for LP for example.

The following example is a continuity of section I, Example 1.

Assume that LP1 has agreed to maintain an amount of 3,000$ reserve. After finalizing the cash remittance operation initiated by User 1. LP1 has only a reserve of 2,896.5$ as shown below:

| | | | Funds held by | |
|---|---|---|---|---|
| | Cash | dCash | the custodian on | |
| Holdings | balance | balance | behalf of LP | Total |
| User1 | 0$ | 0$ | n/a | 0$ |
| User2 | 100$ | 0$ | n/a | 100$ |
| LP1 | 4,106$ | 2,896.5$ | n/a | 7,002.5$ |
| LP2 | 2,900$ | 2,102.5$ | n/a | 5,002.5$ |
| Total | 7,106$ | 4,999$ | n/a | 12,105$ |
| Custodian | 0$ | 1$ | 4,999$ | 5,000$ |

To continue using the app and participating in the system, LP1 needs to deposit or wire 103.5$ at minimum to the custodian. He decides to deposit or wire 200$ instead:

| | | | Funds held | |
|---|---|---|---|---|
| | | | by the | |
| | Cash | dCash | custodian on | |
| Holdings | balance | balance | behalf of LP | Total |
| User1 | 0$ | 0$ | n/a | 0$ |
| User2 | 100$ | 0$ | n/a | 100$ |
| LP1 | 3,906$ | 3,096.5$ | n/a | 7,002.5$ |
| | (−200$ | (+200$ | | |
| | rebalancing) | rebalancing) | | |
| LP2 | 2,900$ | 2,102.5$ | n/a | 5,002.5$ |
| Total | 6,906$ | 5,199$ | n/a | 12,105$ |
| Custodian | 0$ | 1$ | 5,199$ | 5,200$ |

Amounts held by the custodian on behalf of LP1 and LP2 have now increased by 200$. This means that the custodian can issue an amount of 200$ in dCash in favor of LP1.

### Section VI: Multicurrency Environment:

The present system and method can also be used in a multicurrency environment where cash remittance and dCash transfer can be made by users from different countries using different currencies.

Another continuation of section I: Example 1 is used with modified assumptions: Example 1:

Amount of cash to remit: 100 USD

Recipient currency: CAD

Fx rate USD/CAD: 1.3000

LP1 fees: 2.5% LP2 fees: 2.5% Custodian fees: 1%

LP1 holdings: 4,000 USD in cash and 3,000 USD held by custodian (3,000 USD in dCash balance). Total of 7,000 USD.

LP2 holdings: 3,000 CAD in cash and 2,000 CAD held by custodian (2,000 CAD in dCash balance). Total of 5,000 CAD.

Custodian: 7,000 USD held on behalf of LP1 and 5,000 CAD held on behalf of LP2.

Fees: User1 sends 106 USD. User2 receives 130 CAD. User1 will have to pay 6 USD in fees (2.5 USD LP1 fees+1 USD custodian fees+3.25 CAD LP2 fees)

Initial balances:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 106 USD | 0 USD | n/a | 106 USD | 6 USD | 0 USD |
| User2 | 0 CAD | 0 CAD | n/a | 0 CAD | 0 CAD | 0 CAD |
| LP1 | 4,000 USD | 3,000 USD | n/a | 7,000 USD | 0 USD | 0 USD |
| LP2 | 3,000 CAD | 2,000 CAD | n/a | 5,000 CAD | 0 CAD | 0 CAD |
| Total | 4,106 USD | 3,000$ USD | n/a | 7,106 USD | 0 USD | 0 USD |
| | 3,000 CAD | 2,000 CAD | n/a | 5,000 CAD | 0 CAD | 0 CAD |
| Custodian | 0 USD | 0 USD | 3,0005 USD | 3,0005 USD | 0 USD | 0 USD |
| | 0 CAD | 0 CAD | 2,000 CAD | 2,000 CAD | 0 CAD | 0 CAD |

Cashing-in by User1:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0 USD | 103.5 USD | n/a | 103.5 USD | 2.5 USD | 0 USD |
| | (106 USD) | (+106 USD | | | | |
| | | −2.5 USD | | | | |
| | | LP1 fees) | | | | |
| User2 | 0 CAD | 0 CAD | n/a | 0 CAD | 0 CAD | 0 CAD |
| LP1 | 4,106 USD | 2,896.5 USD | n/a | 7,002.5 USD | 0 USD | 2.5 USD |
| | (+106 USD) | (−106 USD | | | | |
| | | +2.5 USD | | | | |
| | | LP1 fees) | | | | |
| LP2 | 3,000 CAD | 2,000 CAD | n/a | 5,000 CAD | 0 CAD | 0 CAD |
| Total | 4,106 USD | 3,000$ USD | n/a | 7,106 USD | 2.5 USD | 2.5 USD |
| | 3,000 CAD | 2,000 CAD | | 5,000 CAD | 0 CAD | 0 CAD |
| Custodian | 0 USD | 0 USD | 3,000 USD | 3,000 USD | 0 USD | 0 USD |
| | 0 CAD | 0 CAD | 2,000 CAD | 2,000 CAD | 0 CAD | 0 CAD |

dCash transfer:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0 USD | 2.5 USD | n/a | 2.5 USD | 1 USD | 0 USD |
| | | (−100 USD | | | | |
| | | −1 USD | | | | |
| | | custodian | | | | |
| | | fees) | | | | |
| User2 | 0 CAD | 130 CAD | n/a | 138 CAD | 0 CAD | 0 CAD |
| | | (+130 CAD) | | | | |
| LP1 | 4,106 USD | 2,896,5 USD | n/a | 7,002.5 USD | 0 USD | 0 USD |
| LP2 | 3,000 CAD | 2,000 CAD | n/a | 5,000 CAD | 0 C AD | 0 CAD |
| Total | 4,106 USD | 2,899$ USD | n/a | 7,005 USD | 1 USD | 0 USD |
| | 3,000 CAD | 2,130 CAD | | 5,130 CAD | 0 CAD | 0 CAD |
| Custodian | 0 USD | 1 USD | 2,899 USD | 2,900 USD | 0 USD | 1 USD |
| | 0 CAD | (+1 USD | 2,130 CAD | 2,130 CAD | 0 CAD | 0 CAD |
| | | custodian | | | | |
| | | fees) | | | | |
| | | 0 CAD | | | | |

Cashing-out by User2:

| | | | Funds held | | | |
|---|---|---|---|---|---|---|
| | | | by the | | | |
| | | | custodian | | | |
| | Cash | dCash | on behalf | | | Fees |
| Holdings | balance | balance | of LP | Total | Fees paid | earned |
| User1 | 0 USD | 0 USD | n/a | 0 USD | 2.6 USD | 0 USD |
| | | (−2.5 USD | | | | |
| | | LP2 fees) | | | | |
| User2 | 130 GAD | 0 CAD | n/a | 130 CAD | 0 CAD | 0 CAD |
| | (+130 CAD) | (−130 CAD) | | | | |
| LP1 | 4,106 USD | 2,896.5 USD | n/a | 7,002.5 USD | 0 USD | 0 USD |
| LP2 | 2,870 CAD | 2,133.25 CAD | n/a | 5,003.25 CAD | 0 CAD | 3.25 CAD |
| | (−130 CAD) | (+130 CAD | | | | |
| | | +3.25 CAD | | | | |
| | | LP2 fees) | | | | |
| Total | 4,106 USD | 2,896.5 USD | n/a | 7,002.5 USD | 2.5 USD | 0 USD |
| | 3,000 CAD | 2,133.25 CAD | | 5,133.25 CAD | 0 CAD | 3.25 CAD |
| Custodian | 0 USD | 1 USD | 2,896.5 USD | 2,897.5 USD | 0 USD | 0 USD |
| | 0 CAD | 0 CAD | 2,133.25 CAD | 2,133.25 CAD | 0 CAD | 0 CAD |

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and related systems have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for managing funds, the method comprising the steps of:
receiving, by a custodian, fund deposits from one or more liquidity providers;
issuing for each fund deposit, by the custodian to a set of user accounts associated with the one or more liquidity providers, a corresponding amount of a digital asset;
receiving, by the one or more liquidity providers, cash deposits from one or more users; and
verifying, by the one or more liquidity providers, the identity of the user submitting each cash deposit;
issuing for each cash deposit from a verified user, by the one or more liquidity providers, a corresponding amount of the digital currency to an associated user account of that user;
wherein the amount of fund deposits and the amount of the digital asset held by each of the custodian, the one or more liquidity providers, and the one or more users, as well as each transaction carried out between custodian, the one or more liquidity providers, and the one or more users, is recorded in an electronic wallet database, each wallet in the wallet database being associated with user data relating to the identity of the wallet owner.

2. A computer-implemented method for managing funds according to claim 1, wherein the method further comprises:
setting, for each liquidity provider, a minimum reserve amount;
checking the database to determine whether a first liquidity provider holds an amount of the digital asset corresponding to the minimum reserve amount;
determining that the amount of the digital asset held by the first liquidity provider is below the minimum reserve amount; and
initiating a protocol to prevent further transactions between the first liquidity provider and the one or more users until the amount of the digital asset held by the first liquidity provider is above the minimum reserve amount.

3. A computer-implemented method for managing funds according to claim 2, wherein the protocol involves one of freezing the assets of the first liquidity provider and freezing a user account associated with the first liquidity provider.

4. A computer-implemented method for managing funds according to claim 3, wherein the method further comprises, in response to receiving an additional fund deposit from the liquidity provider which brings the amount of digital currency held by the first liquidity provider above the minimum reserve amount: unfreezing the assets or user account of the first liquidity provider.

5. A computer-implemented method for managing funds according to claim 1, wherein the method further comprises:
receiving a remittance request from a first user to transfer funds from a cash deposit to a second user, the request specifying an amount to be deposited and transferred;
generating a unique identifier for the transfer request;
communicating the unique identifier to the second user;
receiving, by a first liquidity provider, a cash deposit from the first user;
verifying, by the first liquidity provider, the identity of the first user;
verifying, by the first liquidity provider, that the amount of the cash deposit corresponds to the amount specified in the remittance request; and
transferring, by the first liquidity provider, an amount of digital currency corresponding to the cash deposit to an account associated with the second user.

6. A computer-implemented method for managing funds according to claim 5, wherein the method further comprises:
receiving, by a second liquidity provider, a withdrawal request from the second user;
verifying, by the second liquidity provider, that the identity of the second user corresponds to the second user account; and
issuing to the second user, by the second liquidity provider, a cash amount corresponding to the amount of digital currency transferred to their account.

7. A computer-implemented method for managing funds according to claim 5, wherein the method further comprises calculating and deducting a percentage fee from the transferred amount of digital currency.

8. A computer-implemented method for managing funds according to claim 7, wherein the method further comprises distributing at least a portion of the fee to an account wallet associated with the custodian.

9. A computer-implemented method for managing funds according to claim 7, wherein the method further comprises distributing at least a portion of the fee to an account wallet associated with the first liquidity provider.

10. A computer-implemented method for managing funds according to claim 7, wherein the method further comprises distributing at least a portion of the fee to an account wallet associated with the second liquidity provider.

11. A computer-implemented method for managing funds according to claim 1, wherein the method further comprises storing contact information and transaction history for the one or more user account wallets, liquidity provider account wallets in the database.

12. A computer-implemented method for managing funds according to claim 1, wherein the method further comprises:
receiving, by a first liquidity provider, a withdrawal request specifying a desired withdrawal amount from the first user;
verifying, by the first liquidity provider, that the identity of the first user corresponds to a first user account having a wallet containing a sufficient amount of the digital currency for the withdrawal; and
issuing to the first user, by the first liquidity provider, a cash amount corresponding to the amount in the withdrawal request.

13. A computer-implemented method for managing funds according to claim 12, wherein the method further comprises deducting a percentage fee from the withdrawal amount and distributing the fee to an account wallet of the first liquidity provider.

14. A computer-implemented method for managing funds according to claim 1, wherein the method further comprises:
receiving, by a first liquidity provider, a deposit request specifying a desired deposit amount from the first user;
verifying, by the first liquidity provider, that the identity of the first user corresponds to a first user account;
receiving, from the first user, a cash deposit equal to the deposit amount; and
issuing to a wallet of the first user account, by the first liquidity provider, an amount of digital currency corresponding to the deposit amount.

15. A computer-implemented method for managing funds according to claim 14, wherein the method further comprises deducting a percentage fee from the deposit amount and distributing the fee to an account wallet of the first liquidity provider.

16. A computer-implemented method for managing funds according to claim 1, wherein the method further comprises calculating currency conversion rates for one or more operations between account wallets stored in the database.

17. A computer-implemented method for managing funds according to claim 1, wherein one or more users, the one or more liquidity providers, and the custodian may view wallet balances and initiate operations of the disclosed method via dedicated application software installed on one or more user devices.
